(19) United States
(12) Patent Application Publication
(10) Pub. No.: US 2008/0005137 A1
(43) Pub. Date: Jan. 3, 2008

(54) INCREMENTALLY BUILDING ASPECT MODELS

(75) Inventors: Arungunram C. Surendran, Sammamish, WA (US); Suvrit Sra, Austin, TX (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/427,725

(22) Filed: Jun. 29, 2006

(51) Int. Cl. G06F 7/00

(52) U.S. Cl. 707/101

(57) ABSTRACT

The claimed subject matter relates to an unsupervised incremental learning framework, and in particular, to the creation and utilization of an unsupervised incremental learning framework that facilitates object discovery, clustering, characterization and/or grouping. Such an unsupervised incremental learning framework, once created, can thereafter be employed to incrementally estimate a latent variable model through the utilization of spectral and/or probabilistic models in order to incrementally cluster, discover, group and/or characterize tightly knit themes/topics within document sets and/or streams, thus leading to the generation of a set of themes/topics that better correlate with human perceptual labeling schemes.

### BACKGROUND

With the marked increase in number of people with access to computers and to the Internet, there has been significant increase in quantity of information created, accessed and utilized by individuals for various purposes. Examples of such information include treatises on every topic presently known to man from astronomy to zoology, and financial reports that can be employed to beneficially administer financial portfolios. Given the plethora of information that currently exists, and further in view of the unceasing generation of additional information it has been very difficult for individuals and/or corporations to be able to automatically organize, cluster and analyze such information in an expeditious and contemporaneous manner.

To date, a number of approaches have been proposed to effectively cluster and/or categorize documents based upon underlying word structure contained therein. These approaches have been successful in many ways but they show some deficiency when dealing with large numbers of documents that arrive in a stream over time. Some of the previously posited approaches have required prior identification of both putative number of aspects or topics and general topic areas that possibly might arise. For example, if a topic or topic areas arise during analysis that has not been accounted for during initial setup, these prior techniques either mischaracterize or wrongly cluster the topic. Thus, these prior approaches are unable to adaptively expand their purview to iteratively account for topics and/or general topic areas not specified in advance, with the consequential result that such approaches are prone to erroneously categorizing and/or grouping topics that heretofore have not been identified. Other methods that can grow are computationally expensive and require complex inference.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

The claimed subject matter relates to document clustering, categorization, and characterization. More particularly, an unsupervised technique is provided that constructs a series of functions to discover underlying groups in dyadic data (e.g., data with at least two components). Each function represents one group within the data—when the dyads consist of documents and words, the underlying groups can be thought of as topics. The value of this function for each dyad represents relative importance of the dyad for that group or topic. An approximate minimization procedure (e.g., expectation-functional gradient (EFG)) is employed to estimate the functions. The innovation affords for topics to be extracted one at a time, which facilitates handling data that arrives over time. Accordingly, new data that arrives over time can be processed without having to create a new model that leads to substantial computational savings as compared to conventional approaches to such data handling.

The claimed subject matter can without supervision or intervention discover, cluster, group, categorize, characterize and/or generate a set of output objects (e.g., underlying topics and/or themes) that are meaningful to human perception from a set or stream of input objects (e.g., documents, emails, newsfeed articles, photographic repositories, images, databases, and the like) while preserving major associations between contents (e.g., words, photographs, illustrations, . . . ) of the set or stream of input objects to thereby capture synonymy and preserve polysemy of the contents of the input objects. To this end, an incremental unsupervised learning framework is provided that can discover, cluster, categorize, and/or characterize objects (underlying themes and/or topics) from a collection or set of input objects (documents). The output objects so discovered, characterized, clustered and/or categorized can subsequently be used, for example, to notify a user of the existence of information that they might express and interest in, or which may be relevant to their daily activities.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a system that incrementally and adaptively constructs an unsupervised learning framework and outputs one or more themes/topics.

FIG. 2 illustrates an exemplary interface that can be utilized by the claimed subject matter.

FIG. 3 depicts an exemplary analysis component that can be employed by the claimed subject matter.

FIG. 4 is a block diagram of a notification system that can employ the one or more themes/topics generated by an exemplary modeling system.

FIG. 5 is a flowchart diagram of a method for incrementally and adaptively constructing an unsupervised learning framework.

FIG. 6 is a flowchart diagram of a method that can be employed to iteratively and dynamically construct an unsupervised learning framework wherein the input is supplied as a stream of data.

FIG. 7 is a flow chart diagram of a method for utilizing the one or more topics/themes that can be supplied by a modeling component that implements an unsupervised learning framework.

FIG. 8 is a graphical representation of an aspect model.

FIG. 9 depicts a weighted term-document matrix represented as a bipartite graph.

FIG. 10 is a schematic block diagram illustrating a suitable operating environment for aspects of the subject innovation.

FIG. 11 is a schematic block diagram of a sample-computing environment.

### DETAILED DESCRIPTION

The various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

To date there have been several methods proposed for the analysis, clustering, and indexing of input objects (e.g., a set of documents). Notable amongst these methods have been Latent Semantic Indexing (LSI), Probabilistic Latent Semantic Indexing (PLSI) and Latent Dirichlet Allocation (LDA). The Latent Semantic Indexing (LSI) approach represents individual objects (e.g. topics) via the leading eigenvectors of A^{T} A, where A is an input term-document matrix. The Latent Semantic Indexing (LSI) technique through utilization of such leading eigenvectors can preserve the major associations between words and documents for a given set of data thereby capturing both the synonymy and polysemy of words. However, while the Latent Semantic Indexing (LSI) line of attack preserves major associations between words and documents for a given set of input data, and further has strengths in relation to spectral approaches, the technique has been found to be deficient in that it does not possess strong generative semantics.

In contrast, the Probabilistic Latent Semantic Indexing (PLSI) and Latent Dirichlet Allocation (LDA) modalities both employ probabilistic generative models to analyze, cluster and/or characterize a set of input objects (e.g., documents) and utilizes latent variables in an attempt to capture an underlying topic structure. LDA is considered to be a richer generative model compared to PLSI. Nonetheless, both the Probabilistic Latent Semantic Indexing (PLSI) and Latent Dirichlet Allocation (LDA) approaches are superior to the Latent Semantic Indexing (LSI) methodology in modeling polysemy and have better indexing power. But nevertheless, in comparison to the Latent Semantic Indexing (LSI) technique, the Probabilistic Latent Semantic Indexing (PLSI) and Latent Dirichlet Allocation (LDA) perspectives lack the advantages of spectral methods. Moreover, the batch nature of Probabilistic Latent Semantic Indexing (PLSI) in particular, since it estimates all aspects together, can lead to drawbacks when it comes to model selection, speed, and in application to expanding object sets, for example.

The claimed subject matter can incrementally and without supervision discover, cluster, characterize and/or generate objects (e.g. topics) that are meaningful to human perception from a set of input objects (e.g., documents) while preserving major associations between the contents (e.g., words) of the set of input objects to thereby capture the synonymy and preserve the polysemy of the words. Additionally, the claimed subject matter is dynamically and adaptively capable of incrementally growing as the need arises. To this end, in one embodiment of the invention ideas from density boosting, gradient based approaches and expectation-maximization (EM) algorithms can be employed to incrementally estimate aspect models, and probabilistic and spectral methods can be utilized to facilitate semantic analysis in a manner that leverages advantages of both spectral and probabilistic techniques to create an incremental unsupervised learning framework that can discover, cluster and/or characterize objects (topics) from a collection or set of input objects (documents).

Density boosting is a technique to grow probability density models by adding one component at a time with the aim of estimating the new component and to combine components such that a cost function (e.g., F=(1−a)*G+a*h, where F is the new model, G is the old model, h is the new component, a is a combination parameter, and h and a are estimated such that F is better than G in some way) is optimized. It should be noted that prior to the new component being estimated that each data point is weighted by a factor, such that the factor is small for points well represented by the old model, and high for points not well represented by the old model; this is equivalent to giving more importance to points not well represented in the old model.

Preliminary indications are the proposed incremental unsupervised learning framework can focus on tightly linked sets of input objects (e.g., documents) and the contents (e.g., words, photographs, and the like) of such objects to discover, cluster and/or characterize objects (topics) in a manner that closely correlates to those discoveries, clusters, and characterizations that would be attained by a human intermediary. Additionally, initial results further suggest that such an incremental unsupervised learning framework has advantages in relation to speed, flexibility, model selection and inference, which can in turn lead to better browsing and indexing systems.

Prior to embarking on an expansive discussion of the claimed subject matter, it can be constructive and prudent at this juncture to provide a cursory overview of aspect models. An aspect model is a latent variable model where observed variables can be expressed as a combination of underlying latent variables. Each aspect z thus models the notion of a topic (e.g., a distribution of words, or how often a word occurs in a document containing a particular topic, and in what ratios the word or words occur), therefore allowing one to treat the observed variables (e.g., documents d) as being mixtures of topics. In other words, an aspect model is any model where objects can be represented as a combination of underlying groupings or themes. To illustrate this point, consider receiving a single text document and being requested to cluster the contents of this document. The document might relate to only one topic, or it might relate to a plethora of issues, though on its face the document has no correlative relationship with any particular categorization; simply put, the document appears to be a morass of words. Thus, at the outset of this exercise, upon receipt, the document appears to be a collection of associated words set forth in a document. Subsequent perusal of the received document however may yield, for example, that the document relates to corporate bankruptcies and crude oil. Therefore, in this simplistic example, the latent aspects or topics to which the received document relates are corporate bankruptcies and crude oil, and as such the document, based on these latent aspects, can be grouped as being related to corporate bankruptcies and crude oil. However, it should be noted that in some aspect models, such as PLSI, the observed variables can be considered to be independent of each other given the aspect.

The foregoing illustration can be expanded and represented mathematically as follows. Assuming for instance that a set of documents D={d₁, d₂, . . . , d_{N}} is received, and that each document d is represented by an M-dimensional vector of words taken from a fixed vocabulary W={w₁, w₂, . . . , w_{M}}. The frequency of word w in document d is given by n_{wd}, and the entire input data can be represented as a word-document co-occurrence matrix of size M*N. Further, as stated supra, in PLSI an aspect model is a latent variable model where the observed variables are independent given a hidden class variable z, and that the hidden class variable z (or aspect) models the notion of a topic allowing one to treat documents as mixtures of topics, such an aspect model can decompose the joint word-document probability as:

$$P ( w , d ) = {\sum }_{k = 1}^{K} P ( {z}_{k} ) P ( d \vert {z}_{k} ) P ( w \vert {z}_{k} ) , \qquad ( 1 )$$

where K represents the number of aspect variables.

A problem with the foregoing model however is that it is static as the number of aspects or topics have to be known, or guessed, in advance and further the general topic areas have to be identified prior to employing the model. Thus, for example, if a stream of input documents or metadata is continuously fed into the model the number of putative aspects that can be discovered, clustered, and/or characterized is constrained to the number of general topic areas that were identified prior to the employment of the model. Given this problem therefore it would be beneficial to incrementally and/or dynamically estimate the aspects as the model is being executed and contemporaneously with when the data is being received. The advantage of such an incremental approach being that the modality requires fewer computational resources and consequently can deal with larger and more expansive datasets. Further, such an incremental technique allows the model to grow to accommodate new data (e.g., data for which no general topic areas have been pre-defined) without having to retrain the entire model ab initio. Additionally, such an incremental approach permits easier model selection since one can stop and restart the model if required without the necessity of essentially losing topics already extracted, and thus as a corollary since topics are not lost when the model is stopped and restarted, this provides continuity to a user.

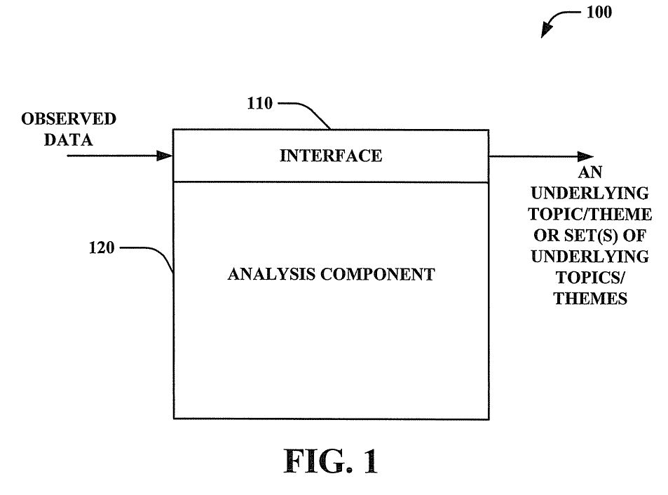

FIG. 1 illustrates a system 100 that incrementally and adaptively constructs an unsupervised learning framework and outputs one or more underlying topics/themes. The system 100 comprises an interface component 110 that receives observed data in the form of a document, a set of documents (e.g., Internet newsfeeds, emails, . . . ) or metadata related to a document. The observed data so received can include, for example, purely textual documents, documents that comprise text, illustrations, and photographs, photographic repositories, metadata in the form of news feeds from internal and/or external sources, emails, database records, and the like. It should be noted at this point that for the purposes of ease exposition and not limitation, the terms “document(s)”, “documents”, “word”, “object”, and “objects” may be employed interchangeably herein and are intended to be utilized in a correlative manner. The interface component 110 upon receipt of the observed data thereupon conveys the received data to a scanning component (described infra) that, depending on the form of observed data received (i e., documents and/or metadata) scans the data to create a uniformly digitized representation of the data. Thus for example, where the observed data is in the form of words and documents, a digitized representation can be obtained by using representations employed in the field of information retrieval such as, for example, term-frequency (tf), “inverse document frequency” weighted term frequency (tf-idf), and the like.

Once the observed data has been scanned and digitized the data is passed to an analysis component 120 that assays the digitized representation of the observed data. The analysis component 120 determines whether objects can be grouped together, such as whether words and documents, genes and diseases, one document and a disparate document (e.g., web pages pointing to each other) can be clustered together. In other words, the analysis component 120 can build aspect models where objects can be represented as a combination of underlying groupings or themes. For example for documents, aspects represent topics and documents can be treated as a combination of themes or topics, e.g. in a document about genes and symptoms of disorders, the underlying themes or topics could relate to some property of genes. For instance, where two different genes affect the liver both could cause similar symptoms, but in combination with other genes cause different disorders. These underlying groupings or clusters can be referred to as aspects.

Nominally, aspect models can be defined as probabilistic and generative models since such aspect models usually propose some model by which observed objects are generated. For instance, in order to generate a document, one can select topics A, B, and C with probabilities 0.3, 0.5, and 0.2 (note that the probabilities sum to 1), and then from the selected topics one can select words according to some underlying distribution distinct to each.

The analysis component 120 can estimate a series of aspects denoted as hₜ (t=1, 2, . . . ), wherein each hₜ (that can of itself be considered as a weak model) captures a portion of the joint distribution P(w, d), such that the totality of the aspects (the hₜs) are learned on a weighted version of the digitized data that emphasizes the parts that are not well covered by a current (or a previously generated) weak model. While each aspect (hₜ) by itself comprises a weak model, the combination Fₜ=(1−α)Fₜ₋₁+αₜhₜ, is one that is stronger than the previous one (e.g., Fₜ₋₁). In other words, the analysis component 120 additively grows a latent model by finding a new component that is currently underrepresented by the existing latent model (e.g., the analysis component 120 weights the digitized data prior to estimating the new component) and adding the new component to the latent model to provide a new latent model.

Additionally, the analysis component 120 estimates the new model based on an optimization of a function, such as a cost function (e.g., the cost of adding a new component and/or the cost of the overall model after the new component is added), a distance function (e.g., the distance between the current model and a pre-existing ideal, for instance KL-distance), a log cost function, etc., that measures the overall cost after adding each new component to the model. In order to utilize one or more of these cost functions, the analysis component 120 can regularize the cost function as needed to avoid generating trivial or useless solutions. For example, the analysis component 120 can regularize (e.g., through use of an L₂ regularizer (not shown) that considers the energy in a probability vector, such as ∥w∥² and ∥d∥²) the functions by adding cost functions together. For instance, if the cost is f(x) and f(x) tends to 0 as x increases, then the cost can arbitrarily be reduced by making x tend to infinity, however in practice this may not be useful, thus the analysis component 120 can provide a regularized version f(x)+b*g(x), where g(x) increases with x and b is a regularization parameter.

In general, a model is built by adding a component as represented as: P(w,d)=(1−α)F(w,d)+αh(w,d), where there are no special assumptions on the model h(w,d). For the previously mentioned case of the aspect model where the underlying objects are independent given the model i.e., h(w, d)=P(w|z_{K})P(d|z_{K}) the joint word-document probability distribution P(w, d) of equation 1, supra, can be represented as follows:

$$P ( w , d ) = {\sum }_{k = 1}^{K - 1} P ( {z}_{k} ) P ( w \vert {z}_{k} ) P ( d \vert {z}_{k} ) + P ( {z}_{K} ) P ( w \vert {z}_{K} ) P ( d \vert {z}_{K} ) \\ P ( w , d ) = ( 1 - α ) F ( w , d ) + α p ( w \vert z ) p ( d \vert z ) ) \qquad ( 2 )$$

where α=P(z_{K}), a mixing ratio, gives the prior probability that any word-document pair belongs to the K^{th} aspect. Note that the second line in the above equations can alternatively be interpreted as a model where h(w,d) is a joint distribution model where independence assumptions need not be used. Thus, given the current estimate F(w, d) the analysis component 120 can determine values for h and α. It should be noted that the analysis component 120 can utilize many types of optimization techniques to determine h and α. For example, the analysis component 120 can employ gradient descent, conjugate-gradient descent, functional gradient descent, expectation maximization (EM), generalized expectation maximization, or a combination of the aforementioned. Nevertheless, for the purposes of explication and not limitation, the claimed subject matter is described herein as utilizing a combination of generalized expectation maximization and functional gradient descent optimization techniques.

Additionally, it should be noted that when estimating h (a probability distribution) one can make assumptions about how h should be represented. For example, one can select h as belonging to a particular family of distributions and thus estimate parameters in this manner. Further, it can be assumed that the distribution forms a hierarchical structure for h, in which case other optimization steps can be required. Moreover, it can also be assumed that different kinds of objects are independent, e.g., it can be assumed that words and documents are independent of one another.

Accordingly, in order to ascertain the values for h and α the analysis component 120 can maximize the empirical log-likelihood Σ_{wd}n_{wd} log P(w,d). Substituting equation (2) into the empirical log-likelihood, the empirical log-likelihood equation can be written as:

$$L = {\sum }_{w , d} {n}_{wd} log ( ( 1 - α ) F ( w , d ) + α h ( w , d ) ) , \qquad ( 3 )$$

over h and α. However, it is difficult to optimize this function directly. Often the optimization is done using a different function that is called a “surrogate” function or in some circles, a Q-function. It is so called because the two functions share some properties such that optimizing the latter will lead to optimizing the former. A surrogate function can be constructed in many ways. One way is to use a function that forms a tight lower bound to the optimization function. For example, in this instance one can write the surrogate function as:

$$Q = {\sum }_{w , d} {n}_{wd} \{ ( 1 - {p}_{wd} ) log ( ( 1 - α ) F ( w , d ) / ( 1 - {p}_{wd} ) ) + {p}_{wd} * log ( α h ( w , d ) / {p}_{wd} ) \qquad ( 4 )$$

### This is also the principle used in the EM algorithm, which has the expectation (E-) step and the maximization (M-) step to optimize the surrogate function so that the parameters are estimated.

The analysis component 120 having rendered the surrogate function can utilize the following expectation step (E-step):

$${P}_{wd} = \frac{α h ( d , w )}{( 1 - α ) F ( d , w + α h ( d , w )} . \qquad ( 5 )$$

which is obtained by optimizing the surrogate function (e.g. equation (4)) over P_{wd} which are also known as the hidden parameters.

The M-step involves estimating the model parameters so that the surrogate function is maximized. In a generalized EM (GEM) approach the surrogate function need not be maximized but just increased (or decreased as appropriate). This can be done in many ways e.g., using a conjugate gradient approach, a functional gradient approach, etc. In this instance, a functional gradient approach is adopted to estimate function h, and the parameters are estimated such that the expected value of the first order approximation of the difference between the optimization function before and after the new model is improved. Specifically if the old model is F and the new model is F′ the aim is to maximize E{L(F′)−L(F)} which when approximated using a first order Taylor expansion, will depend only on the functional gradient of L at

$$F ∇ L ( F ) = \frac{\partial L ( ( 1 - α ) F + α h )}{\partial α} .$$

In other words, estimate h such that this functional derivative is maximized and is at least non-negative. Thus, utilizing the log cost function, the functional derivative can be written as

$$α {\sum }_{w , d} \frac{{n}_{wd} {p}_{wd}}{F ( w , d )} ( h - F ) ,$$

and if the negative of the log cost function with an L₂ regularizer is employed, the same derivative can be written as

$$- α {\sum }_{w , d} \frac{{n}_{wd} {p}_{wd}}{F ( w , d )} ( h - F ) + λα {‖ h ‖}^{2} .$$

### The former being a maximization problem and the latter being a minimization problem.

The above minimization can be done in many ways. Through utilization of a log cost function with a regularizer (e.g. an L₂ regularizer) as shown above, one can estimate h such that:

$$h = {arg min}_{h} - α {\sum }_{w , d} \frac{{n}_{wd} {p}_{wd}}{F ( w , d )} h + λα {‖ h ‖}^{2} ,$$

where ∥h∥² is the norm of h. Further, if one assumes conditional independence, e.g. h(w,d)=p(w|z)p(d|z), then based on this assumption, one can use a different form of the regularizer which depends on the norms of w=p(w|z) and d=p(d|z) such that

$$h = {arg min}_{h} - α {\sum }_{w , d} \frac{{n}_{wd} {p}_{wd}}{F ( w , d )} h + v α {‖ w ‖}^{2} + μα {‖ d ‖}^{2}$$

where ν and μ are two different regularization parameters. If a new matrix V of dimensions w×d whose entries are

$$\frac{{n}_{wd} {p}_{wd}}{F ( w , d )}$$

were created, then the above estimation can be rewritten as w,d=arg_{w,d}min−w^{t}Vd+νw^{t}w+μd^{t}d. Which can be solved by finding the derivative of the cost with respect to w, d and setting these to zero, resulting in a pair of iterative updates. Further assuming that ν, μ are both equal to 1 the result is a pair of assignments that need to be used iteratively to get to a solution:

w=Vd and d=V^{t}w. (spectral M-step). (6)

The solution for this pair of equations are the top left and right singular vectors of the matrix V, leading to a spectral approach (e.g., methods and techniques that identify and employ singular values/eigenvalues, singular vectors/eigenvectors of matrices, etc.). Adoption of such a spectral approach facilitates locating tight clusters or groups of objects (e.g., how well connected the underlying objects are).

To illustrate a group of objects that are tightly clustered, consider a graph of words and documents wherein a line or link is drawn between the word and the document if and only if the word exists in the document, and a link strength is indicated by how often a word occurs in the document. Thus, where many words together occur in a plethora of documents and all the strengths between these groups of words and documents are strong then this can be perceived as being a tight cluster.

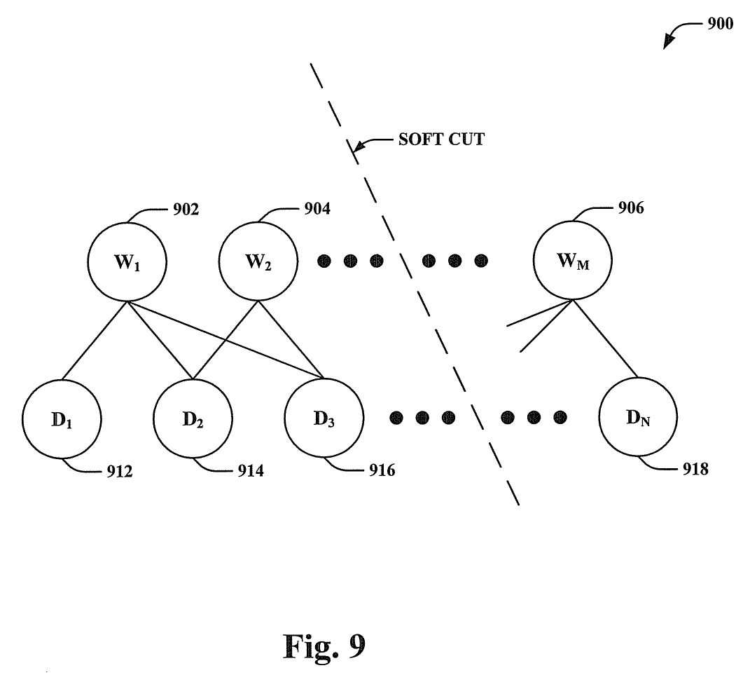

A weighted term-document matrix can be viewed as a bipartite graph with words on one side and documents on the other. An illustration of such a bipartite graph is provided in FIG. 9. Thus, an iteration by the analysis component 120 utilizing equation (6) can be perceived as a soft cut of the graph to separate the graph into two partitions, one which represents the desired cluster and the rest of the graph. In other words, this line of attack favors words and documents that are strongly connected to each other with the beneficial consequence that the chance of discovering, grouping, clustering and/or characterizing weakly connected components (e.g. mixed topics/themes) can be significantly mitigated. Viewed in this light, one could use any other spectral graph partitioning approach at this step instead.

Alternatively, Equation (6) can be viewed as ranking the relevancy of objects based on their link or relations to other objects. For example, for words and documents the most relevant words are the ones that tend to occur more often in more important documents, and the important documents are the ones that contain more of the key words. This co-ranking can be implemented in any other way using other weighted ranking schemes.

Thus, once h is estimated, α can be estimated using one of many methods. For example, a line search can be utilized to estimate α such that

$$α = {arg max}_{α} {\sum }_{w , d} L ( ( 1 - α ) F + α h )$$

The analysis component 120 can employ many different criteria to evaluate whether to cease adding more components, for example, the analysis component 120 can ascertain that the digitized data is sufficiently well described by a current model, the weights for most of the digitized data is too small, and/or the cost function is not sufficiently decreasing. Additionally, the analysis component 120 can also ascertain that a stop or termination condition has been attained where a functional gradient ceases to yield positive values, a pre-determined numbers of clusters has been obtained, and/or whether an identified object has been located.

Accordingly, utilization of equation (6) by the analysis component 120 effectuates a convergence of the final scores to the leading left and right singular vectors of a normalized version of T, and for irreducible graphs, in particular, the final solution is unique regardless of the starting point, and the convergence is rapid. Thus, if a connection matrix has certain properties, such as being irreducible, there will be a quick convergence to the same topic/theme regardless of how the model is initialized. Nevertheless, not all word-document sets reduce to irreducible graphs, but this shortcoming can be overcome by the analysis component 120 introducing weak links from every node to every other node in the bipartite graph.

By modify a PLSI algorithm aspect models can be built incrementally, each aspect being estimated one at a time. However, before each aspect is estimated the data should be weighted by 1/F. Further, at the start of the PLSI algrorithm w and d are initialized by the normalized unit vector and the regular M-step is replaced by the spectral M-step in Equation (6).

Such an algorithm can thus facilitate a system that can be adapted to accommodate new unseen data as it arrives. To handle streaming data, one should be able to understand how much of the new data is already explained by the existing models. Once this is comprehended, one can automatically ascertain how much of the new data is novel. In one embodiment of the claimed subject matter a “fold-in” approach similar to the one used in regular PLSI can be adopted. Since the function F represents the degree of representation of a pair (w,d) once has to estimate this function for every data point, which in turn means that one has to figure out how much each point is represented by each aspect h i.e., one needs to estimate p(w|h) and p(d|h) for all the new (w,d) pairs in the set of new document X. To this end, one first keeps p(w|z) values fixed for all the words that have already been seen, only estimating the probabilities of the new words (the p(w|z) vectors are renormalized as needed). Then using the spectral projections (Equation (6)) p(d|z) is estimated while still holding p(w|z) fixed. Using this one can compute new F for all X. This is the end of the “fold-in” process. Once the new documents are folded-in, one can use the new F to run more iterations on the data to discover new themes.

To provide further context and to better clarify the foregoing, the following exemplary algorithmic discussion of the claimed subject matter is presented. From the foregoing discussion it can be observed that the unsupervised learning framework generated by system 100 has two constituent parts: a restriction element where based on already discovered, clustered, grouped and/or characterized topic(s)/theme(s), this approach defines a restricted space; and a discovery feature that employs the restricted space located by the restriction component to spectrally ascertain new coherent topic(s)/theme(s) and modify the restriction based on newly identified coherent topic(s)/theme(s). These two constituent parts loop in lock step until an appropriate topic/theme is identified.

Constructing a Unsupervised Learning Framework (ULF)
ULF(X)
Input: X input co-occurrence matrix
Output: P(w, d).
[M, N] ← size(X)
{Initialization}
F(w, d) = 1/(M * N) ∀(w, d)
for k = 1 to K (or convergence)

(h(w, d), α) ← DISCOVERTOPIC(X, F)
F(w, d) = (1 − α)F(w, d) + αh(w, d)

endfor
return P(w, d) = F(w, d)
Estimating h and α
DISCOVERTOPIC(X, F)
Input: X data matrix, F current model
Output: new aspect h, mixing proportion α
[M, N] ← size(X)
{Initialization}
T = X ./ F (initial restriction)
w ← rand(M, 1); d ← rand(N, 1)
while not converged

{M-step}
w = Td
d = T^{T}w
Normalize w, d
Calculate α using line search
h = wd^{T}
{E-step}
$Compute P = [ P ( z \vert w , d ) ] using {P}_{wd} = \frac{αh ( d , w )}{( 1 - α ) F ( d , w + αh ( d , w )}$
T = X .* P

end while
return h, α
Constructing a ULF with streaming data
ULF(X)
Input: new input data X and existing models p(w|z), p(z), z=1,...,L
Output: P(w, d).
K = L (initial number of themes)
{Initialization}
F(w, d) = MAPtoTHEMES(X,p(w|z),p(z))
while new themes are to be added

(h(w, d), α) ← DISCOVERTOPIC(X, F)
F(w, d) = (1 − α)F(w, d) + αh(w, d)
K = K + 1

end while
return P(w, d) = F(w, d)
Fold-in new data
MAPTOTHEMES(X, p(w|z),p(z))
Input: X data matrix, current model consisting of p(w|z) and p(z) for all
z's
Output: new p(d|z) for all d's and new F
[M, N] ← size(X)
{Initialization}
T = X
For k=1 to K

while not converged

{M-step}
w = p(w|zₖ)
d = T^{T}w
Normalize w, d
h = wd^{T}
{E-step}
$Compute P = [ P ( z \vert w , d ) ] using {P}_{wd} = \frac{αh ( d , w )}{( 1 - α ) F ( d , w + αh ( d , w )}$
T = X .* P

end while
p(d|z)=d
F(w,d)=(1−α)F(w,d) + αh(w,d)

end for
return p(d|z) for all z and updated F

Initially upon invocation of each ULF step a new F is employed to select a restriction equal to 1/F which effectively up-weights data points that are poorly represented by F (e.g. ULF commences with a uniform initialization of F). Having selected an appropriate restriction, ULF invokes DISCOVERTOPIC to compute the new aspect h as well as its mixing proportion α after which F is updated and the next ULF iteration commences. The number of boosting steps K, can either be specified by the user or can be determined automatically through some stopping criterion as discussed before.

In addition, and in order to streamline the totality of topics/themes rendered and to curtail the occurrence of redundant topics/themes, the claimed subject matter can perform ancillary post-processing at the completion of each ULF iteration. For example, an analysis of the word distribution of the newest topic/theme identified can be effectuated to ensure that newly identified topics/themes are not correlative with one or more topics/themes that may have been identified during earlier iterations of ULF. Where a correspondence between the newly identified topic/theme and the previously identified and/or clustered topics/themes becomes apparent, post-processing can merge the topics/themes based on a pre-determined threshold. Such merging effectively creates an interpolated version of the model where the new word distribution is, for example,

(p(w|z′ᵢ)=(p(zᵢ)p(w|zᵢ)+p(zⱼ)p(w|zⱼ))/(p(zᵢ)+p(zⱼ)). (12)

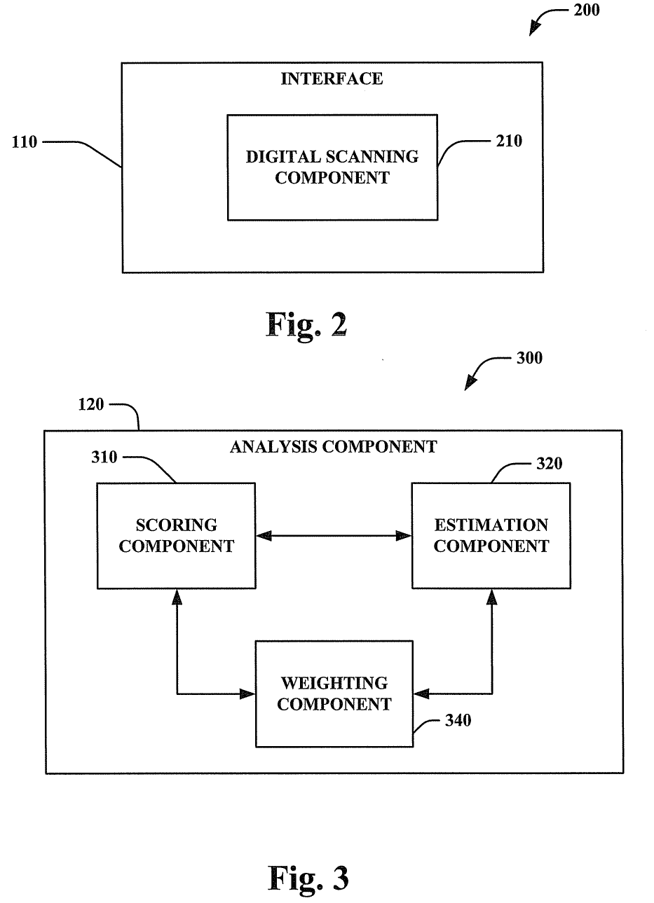

With reference to FIG. 2, depicted therein is a representation of the exemplary interface 110 employed by the claimed subject matter. The interface 110 can be employed to receive observed data in the form of documents and/or metadata related documents, photographs, news feeds, and the like, and can include a digital scanning component 210 that can be utilized to accept the incoming data, process, and convert such data into a digital representation compatible with other aspects of the claimed subject matter. The processing and conversion undertaken by the digital scanning component 210 can include, for example, scanning paper documents and transforming the paper documents into digital form (e.g., via Optical Character Recognition (OCR) techniques), selectively removing stop words (those words which are so common that they are useless in the context of object discovery, categorization and/or grouping) from the digital document/form, and employing statistical techniques to evaluate how important a word is to a document (e.g. term-frequency (tf), term frequency-inverse document frequency (tf-idf) weighting). In the context of removing stop words, words that can be considered stop words are those that occur with great frequency, but do not impart, or detract from, if omitted, the substantive and/or contextual meaning of the words that constitute the document, typically these include articles, adverbials and/or adpositions (e.g., prepositions and postpositions). For instance, in the English language obvious stop words can include, for example, “a”, “of”, “the”, “I”, “it”, “you”, and “and”.

FIG. 3 is a more detailed illustration of the analysis component 120. The analysis component 120 can include a scoring component 310 that assigns relevancy score(s) to the digital representations of documents and the words contained within these digital representations based on how tightly the documents and words are linked. The relevancy score(s) so determined and assigned by the scoring component 310 can be conveyed to an estimation component 320 that iteratively effectuates creation of a new aspect or latent model wherein equations (2)-(6) and the received relevancy score(s) are variously employed and interpolated to facilitate the creation of the new aspect and to obtain an associated mixing ratio. Additionally, the analysis component 120 can also include a weighting component 340 that automatically makes determinations, based at least on the mixing ratio of a newly generated aspect received from the estimation component 320, and relevancy score(s) received from the scoring component 310, whether there exist previous aspects with similar word distribution characteristics, in which case the newly generated aspect can be merged, deleted, or assigned a reduced weight. Merging is performed, for example, when a newly generated aspect is too similar to an aspect that currently exists in the aspect model, whereas down-weighting and deletion/elimination can be performed when it is determined that a currently existing aspect represents data that occurred too far back in time to be of any current relevance. The results of the weighting component 340 can subsequently be communicated to the scoring component 310 and the estimation component 320.

It should be noted that the analysis component 120 can also receive input from a user interface (not shown), wherein certain thresholds can be specified. Alternatively, the analysis component 120 can automatically and selectively ascertain appropriate thresholds for use by the various components incorporated therein. For example, a threshold can be utilized by the weighting component 340 wherein the weighting component 340 compares a score received from the scoring component 310 with the threshold specified or ascertained to determine whether a newly created aspect should be merged, eliminated, down-weighted or up-weighted (i.e., when a newly created aspect has never been, or has rarely been, seen during prior iterations).

While the claimed subject matter is described in terms of generative models, the subject matter as claimed can also find application with respect to non-generative models, for example, where the aspect model does not employ a probability distribution but rather utilizes any function, provided that the function(s) is non-negative. Thus, in this non-generative embodiment the non-negative function provides a score for each object such that the score provides a measure of the relevance of the object to a given aspect. Nevertheless, aside from this distinction the claimed subject matter operates in the same manner provided above for generative models including utilization of the log cost function and the combination of the expectation maximization and functional gradient approaches.

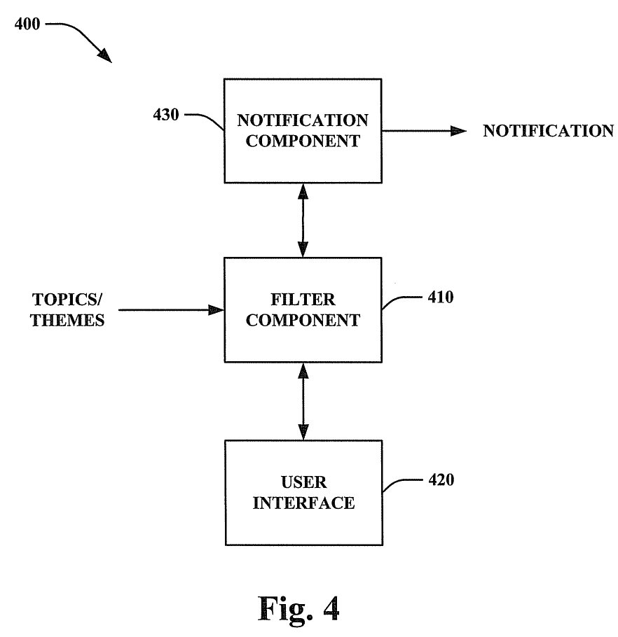

FIG. 4 illustrates a system 400 that utilizes the one or more topics/themes supplied by the exemplary system 100 described above to automatically notify a user of topics/themes of interest to the user. System 400 includes a filter component 410 that receives one or more topics/themes from a modeling system (not shown) that incrementally and dynamically constructs an unsupervised learning framework as well as input related to user preferences (e.g., topics/themes of interest to the user, the means of communication that the user wishes to be notified with, etc.) from a user interface 420. The filter component 410 continuously scrutinizes the incoming topics/themes to locate or determine topics/themes that match the preferences entered by the user through the user interface 420. Upon ascertainment of a match or correspondence the filter component 410 can communicate with a notification component 430 that can generate an appropriate notification depending on a modality or modalities of communication that the user entered as a communication means. Such modalities of communication can include Personal Digital Assistants (PDAs), cell phones, smart phones, pagers, watches, microprocessor based consumer and/or industrial electronics, software/hardware applications running on personal computers (e.g., email applications, web browsers, . . . ), and the like. It should be noted for example, that while the user interface 420 is illustrated as being a distinct element separate unto itself, such user interface 420 can be incorporated into the one or more communication instrumentalities that may be employed to receive notifications from the notifications component 430. Additionally, it should also be noted by way of example and not limitation, that the notification component 430 can attempt to direct the one or more notifications to a plurality of user specified communication instrumentalities, or it can selectively nominate a series of communication modalities based on a ranked list wherein the ranked list is provided as part of the entered user preferences.

As will be appreciated, various portions of the disclosed systems above and methods below may include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the interface component 110, analysis component 120, filter component 410 and notification component 430 can as warranted employ such methods and mechanisms to infer context from incomplete information, and learn and employ user preferences from historical interaction information.

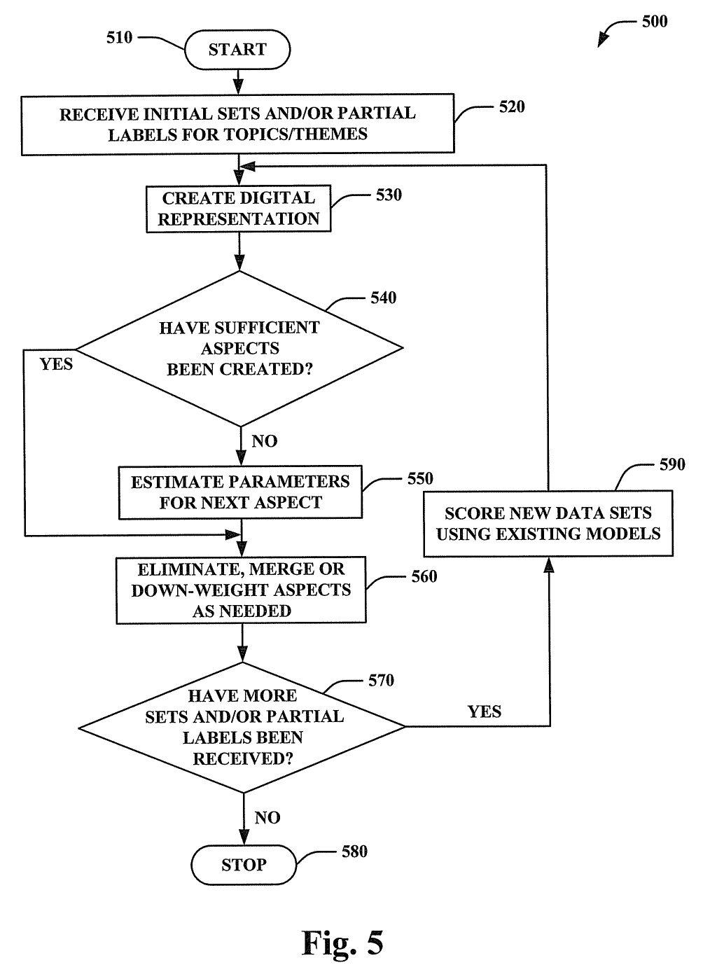

In view of the exemplary systems described supra, methodologies that may be implemented in accordance with the disclosed subject matter will be better appreciated with reference to the flow charts of FIGS. 5-7. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed hereinafter and throughout this specification are capable of being stored on an article of manufacture to facilitate transporting and transferring such methodologies to computers.

Referring to FIG. 5, an exemplary methodology 500 employed to incrementally and adaptively construct an unsupervised learning framework is illustrated. At reference numeral 510 the method commences and proceeds to numeral 520 wherein initial data sets (documents, photographs, and the like) and partial labels, if any, for topic/theme discovery/clustering are received. At 530 the received data sets are scanned to create an applicable and appropriate digital representation of the received data sets. Scanning and conversion of the communicated data sets into applicable and appropriate digital representations can involve and include, for example, utilizing Optical Character Recognition (OCR) technologies to transform paper documents into digital form, removing stop words from the digital form, and employing statistical techniques, for instance, term-frequency-inverse document frequency (td-idf) weightings, to assess the importance of a word(s) with respect to the document within which the word(s) is contained. At 540 a query is posited to ascertain whether a sufficiency of aspects have been created. Where the sufficiency of aspects is not met (NO) at 540, the methodology continues to reference numeral 550. Conversely, if at 540 the sufficiency of aspects is satisfied (YES), the methodology advances to reference numeral 560. At 550 the methodology estimates parameters for the next aspect, this can, for example, include utilizing equations (2)-(6) and/or employing the exemplary algorithms elucidated supra. Once the methodology has estimated the necessary parameters at 550, the methodology progresses to 560 whereupon the aspect can be eliminated, merged or down-weighted/up-weighted as appropriate. Such merging, down-weighting/up-weighting and elimination can be based, for example, on a threshold automatically derived, obtained via user input, and/or through interpolation (e.g., employing equation (12)). At 570 an inquiry is made as to whether further data sets and/or partial labels, if any, for topic/theme discovery have been received. Where it is determined that no more data sets and/or partial labels have been received at 570 (NO), the methodology continues to reference numeral 580 whereupon the methodology terminates. Alternatively, where further data sets and partial labels are received at 570 (YES) the method advances to 590 where relevancy scores can be assigned to documents and words that constitute the document based on how tightly linked the words and documents are. It should be noted that the aforementioned methodology can typically be used where the flow of incoming data sets and partial labels are relatively static.

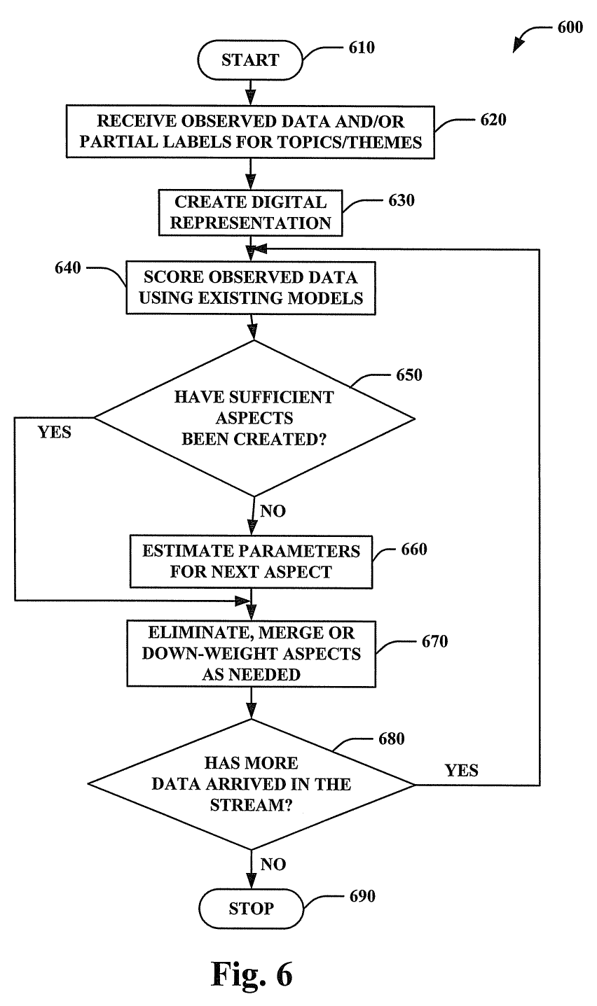

FIG. 6 illustrates an exemplary method 600 that can be utilized to incrementally and adaptively construct an unsupervised learning framework. In contrast to the methodology provided in FIG. 5, the method 600 can be employed where there is a continuous flow of data or documents being received (e.g., newsfeeds, emails, etc.). The method commences at 610 and advances to reference numeral 620 where streams of observed data (e.g., via newsfeeds, the Internet, emails, etc.) and/or partial labels for topics/themes for topic/theme discovery/clustering, if any, are received. At 630 the received streams of data are transformed into an applicable and appropriate digital representation. This conversion can entail, for example, removing stop words and employing one or more statistical techniques to assess the importance of the words (or objects) contained within the digital form with the digital form itself. At 640 relevancy scores can be assigned to the digital form and words that constitute the digital form based on how tightly linked the words and digital form are. At 650 the method determines whether sufficient aspects have been created. If in response to the query at 650 the response is negative (NO), the method continues to 660. Alternatively, if the response to the query at 650 is affirmative (YES) the method advances to 670. At 660 the method estimates parameters for the next aspect through utilization of equations (2)-(6) expounded upon above and/or via utilization of the exemplary algorithms outlined above, for example. At 670 the results from 660 are considered to determine whether the aspect needs to be eliminated, merged or up-weighted/down-weighted, at which point the method continues to 680 wherein a query is posed to determine whether more streaming data has been received. Where more streaming data has been received, the method continues to 640. Conversely, whether the observed data stream has ceased, the method advances to 690 whereupon the method terminates.

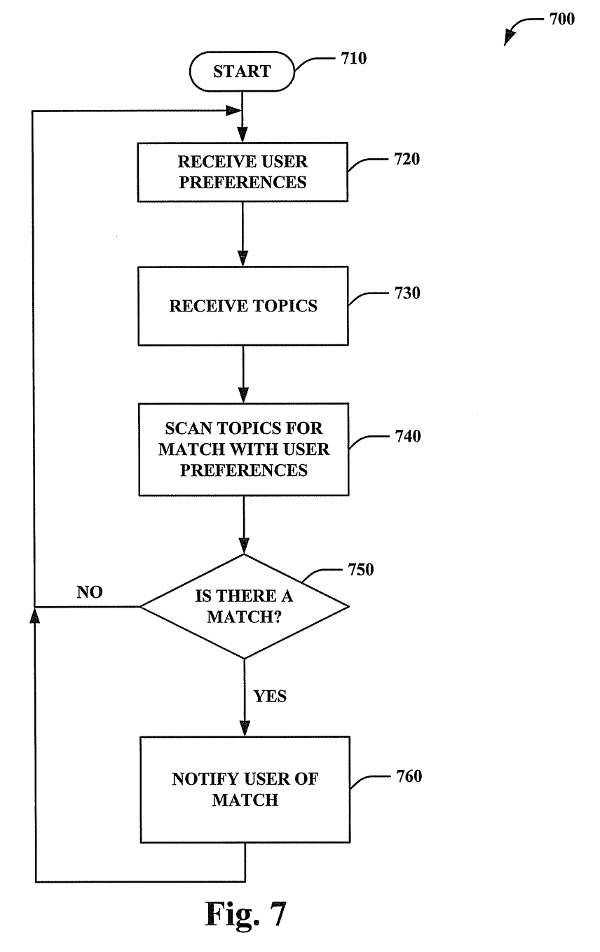

FIG. 7 depicts a method 700 employed to utilize the one or more topics/themes that are supplied by a modeling component that incrementally and dynamically constructs an unsupervised learning framework to notify a user of topic(s)/theme(s) of interest. The method commences at 710 and proceeds to 720 wherein a user interface is employed to elicit one or more user preference from a user. The user preferences may relate to the type(s) of communications modality the user wishes to receive notifications on, the categories of topics/themes that the user might be interested in, and the frequency with which the user wishes to be apprised should topic(s)/theme(s) be discovered, and the like. Once the user has entered the one or more preferences through, for example, a graphical user interface (GUI), the method advances to 730 whereupon one or more topics/themes are received from the modeling component. The topics/themes may be supplied as a continuous stream, or the topics/themes may be received individually in the form of documents. At 740 and 750 an assessment component is employed to continuously scan the topics/themes being supplied by the modeling component to ascertain whether one or more of the topics/themes being supplied by the modeling component comport with any of the topics/themes or categories of topics/themes in which the user elicited an interest. At 750 in particular, where the assessment component determines that a match exists between the topic(s)/theme(s) supplied and the user elicited interest (YES) the method advances to 760 wherein the user is appropriately notified on the communication instrumentality or instrumentalities indicated by the user at 720 and the method returns to 720. Conversely at 750 where the assessment component does not locate a match between the topic(s)/theme(s) being received from the modeling component and the user elicited interest the method cycles back to 720.

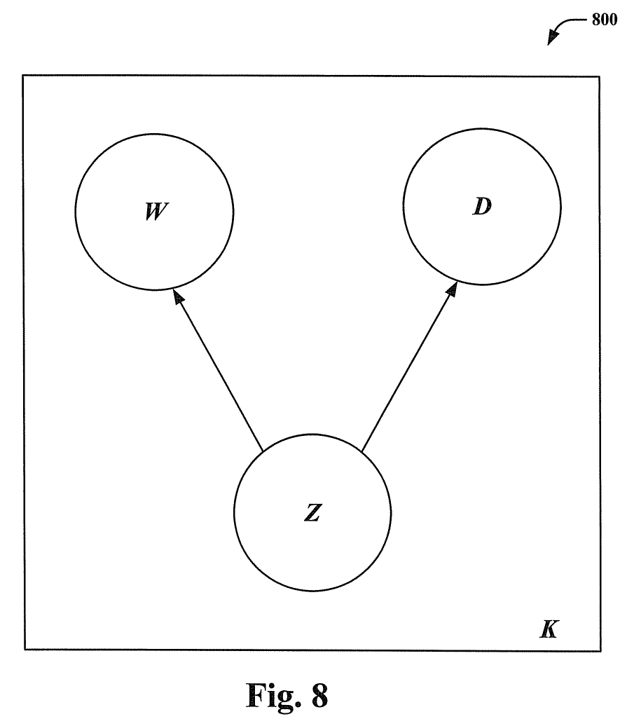

FIG. 8 depicts a graphical representation of a specific form of an aspect model called a “symmetric aspect model” wherein W represents a set of words or a fixed vocabulary W={w₁, w₂, . . . , w_{M}}, D represents a set of documents D={d₁, d₂, . . . , d_{N}}, K denotes the number of aspect variables, and Z is representative of a set of hidden or latent aspects encompassed in the set of documents D and definable by the fixed vocabulary W. As can be appreciated from viewing this illustration the set of discoverable, but latent, aspects Z is dependent on, and a function of both the set of documents D and the set of words W.

FIG. 9 illustrates a weighted term-document matrix represented as a bipartite graph 900 with word nodes (902, 904 and 906) on one side and document nodes (912, 914, 916, and 918) on the other. A random walk (or traversal) of this bipartite graph 900 requires that a word/document node be randomly selected whereupon depending whether a word or document node has been selected the next node should be a document or a word node. For example, if document node 912 is selected at random observation of the bipartite graph 900 indicates that the only possible node to which the document node 912 is connected is word node 902, thus in order to effectively advance from node 912 one must move to word node 902. Having progressed to word node 902 one is presented with two alternatives, proceed to document node 914 or document node 916, thus in such a manner the bipartite graph can be effectively traversed. Nevertheless, the bipartite graph also associates probabilities with each of the inter-nodal jumps. These inter-nodal probabilities are based on the connection structure of the graph. The more connected or relevant a particular node is, the higher the chance of ending up in it (provided there is a path to get to it from any other node—such graphs are referred to as irreducible). As will be observed from the exemplary bipartite graph 900 the most connected nodes in this instance are word nodes 902 and 906. In the context of the presently claimed subject matter, the probability of ending up in either of these two nodes when starting at any random point is commensurately high. Thus, traversal of such an exemplary bipartite graph 900 as utilized by the claimed subject matter can be perceived as performing a soft cut on the graph to extract one tightly-knit component from it, or in other words, favoring words and documents that are strongly connected to each other. A further ancillary benefit of such a traversal is that it reduces the chances of discovering mixed topics/themes.

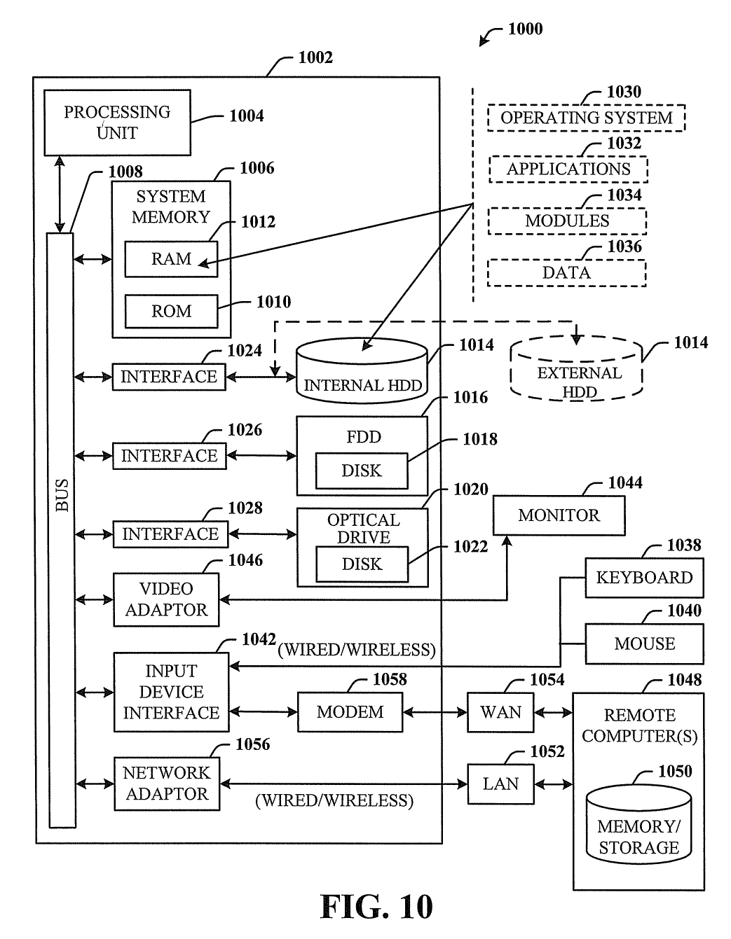

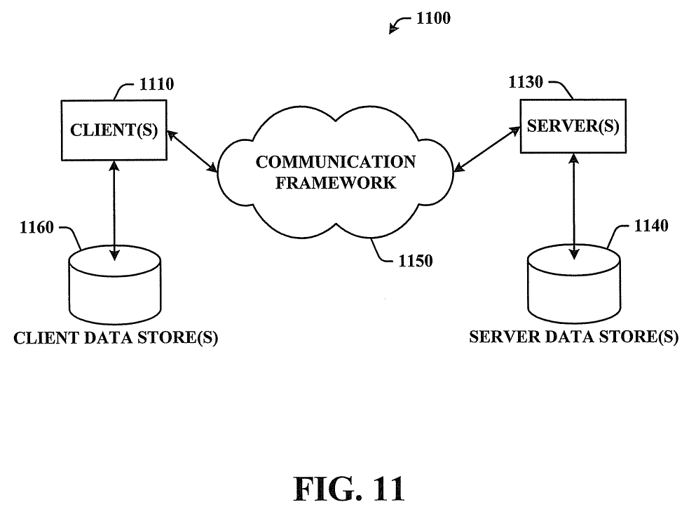

In order to provide a context for the various aspects of the disclosed subject matter, FIGS. 10 and 11 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed innovation can be practiced on stand-alone computers. In a distributed computing environment, program modules may be located in both local and remote memory storage devices.

As used in this application, the terms “component,” “system” and the like are intended to refer to a computer-related entity, either hardware, a combination of hardware and software, software or software in execution. For example, a component may be, but is not limited to being, a process running on a processor, a processor, an object, an instance, an executable, a thread of execution, a program and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner. It is to be appreciated that a myriad of additional or alternate examples could have been presented, but have been omitted for purposes of brevity.

Artificial intelligence based systems (e.g. explicitly and/or implicitly trained classifiers) can be employed in connection with performing inference and/or probabilistic determinations and/or statistical-based determinations as in accordance with one or more aspects of the subject innovation as described hereinafter. As used herein, the term “inference,” “infer” or variations in form thereof refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject innovation.

Furthermore, all or portions of the subject innovation may be implemented as a system, method, apparatus, or article of manufacture using standard programming and/or engineering techniques to produce software, firmware, hardware or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

With reference to FIG. 10, an exemplary environment 1010 for implementing various aspects disclosed herein includes a computer 1012 (e.g., desktop, laptop, server, hand held, programmable consumer or industrial electronics . . . ). The computer 1012 includes a processing unit 1014, a system memory 1016, and a system bus 1018. The system bus 1018 couples system components including, but not limited to, the system memory 1016 to the processing unit 1014. The processing unit 1014 can be any of various available microprocessors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable ROM (EEPROM), or flash memory. Volatile memory 1020 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1012 also includes removable/non-removable, volatile/non-volatile computer storage media. FIG. 10 illustrates, for example, disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in suitable operating environment 1010. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the present invention can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012 and to output information from computer 1012 to an output device 1040. Output adapter 1042 is provided to illustrate that there are some output devices 1040 like displays (e.g., flat panel and CRT), speakers, and printers, among other output devices 1040 that require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit-switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1016, it can also be external to computer 1012. The hardware/software necessary for connection to the network interface 1048 includes, for exemplary purposes only, internal and external technologies such as, modems including regular telephone grade modems, cable modems, power modems and DSL modems, ISDN adapters, and Ethernet cards or components.

FIG. 11 is a schematic block diagram of a sample-computing environment 1100 with which the subject innovation can interact. The system 1100 includes one or more client(s) 1110. The client(s) 1110 can be hardware and/or software (e.g., threads, processes, computing devices). The system 1100 also includes one or more server(s) 1130. Thus, system 1100 can correspond to a two-tier client server model or a multi-tier model (e.g., client, middle tier server, data server), amongst other models. The server(s) 1130 can also be hardware and/or software (e.g., threads, processes, computing devices). The servers 1130 can house threads to perform transformations by employing the subject innovation, for example. One possible communication between a client 1110 and a server 1130 may be in the form of a data packet transmitted between two or more computer processes.

The system 1100 includes a communication framework 1150 that can be employed to facilitate communications between the client(s) 1110 and the server(s) 1130. The client(s) 1110 are operatively connected to one or more client data store(s) 1160 that can be employed to store information local to the client(s) 1110. Similarly, the server(s) 1130 are operatively connected to one or more server data store(s) 1140 that can be employed to store information local to the servers 1130. By way of example and not limitation, the systems as described supra and variations thereon can be provided as a web service with respect to at least one server 1130. This web service server can also be communicatively coupled with a plurality of other servers 1130, as well as associated data stores 1140, such that it can function as a proxy for the client 1110.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations in form thereof are used in either the detailed description or the claims, such terms are intended to be inclusive in a manner similar to the term “comprising” as “comprising” is interpreted when employed as a transitional word in a claim.

What is claimed is:

1. A system that builds an aspect model from observed data, comprising:
an interface component that receives and incrementally extracts one or more aspects from the observed data; and
an analysis component that merges the one or more extracted aspects with an existing aspect model.

2. The system of claim 1, the analysis component determines whether the existing aspect model adequately describes the observed data.

3. The system of claim 2, when the analysis component ascertains that the existing aspect model inadequately describes the observed data, the analysis component indicates that additional aspects are needed.

4. The system of claim 1, the analysis component assigns weights to one or more parts of the observed data based at least in part on an adequacy determination on whether the existing aspect model describes the observed data.

5. The system of claim 5, the analysis component assigns a low weight to observed data adequately described by the existing aspect model, and assigns a high weight to observed data inadequately described by the existing aspect model.

6. The system of claim 1, the analysis component further comprising a scoring component that assigns a relevancy score to the observed data for each of the one or more extracted aspects.

7. The system of claim 6, the scoring component assigns probabilities to the observed data for each of the one or more extracted aspects.

8. The system of claim 6, the analysis component further comprising a weighting component that determines, based at least in part on the relevancy score and a mixing ratio, whether the one or more extracted aspects should be merged, deleted and/or assigned a reduced weight or an enhanced weight.

9. The system of claim 8, based at least in part on the relevancy score and the mixing ratio the analysis component eliminates existing aspects from the existing aspect model.

10. The system of claim 1, the one or more extracted aspects selected based at least in part by spectral methods.

11. The system of claim 1, the one or more extracted aspect selected based at least in part by a combination of probabilistic and spectral methods.

12. The system of claim 1, the interface component receives new data and the analysis component determines whether the new data is adequately described by the existing aspect model.

13. The system of claim 1, the interface component determines one or more stopping creation.

14. A method for building an aspect model from observed data, comprising:
employing a component to receive a stream of observed data;
incrementally extracting one or more aspects from the stream of observed data; and
adding the one or more extracted aspects to an existing aspect model.

15. The method of claim 14, the component employs a mechanism to transform the stream of observed data to a digital form.

16. The method of claim 15, the component selectively removes at least one stop word from the digital form.

17. The method of claim 14, the aspect model constructed utilizing a cost optimization function.

18. The method of claim 14, further comprising utilizing at least one statistical technique to evaluate a relative importance of the observed data in relation to every aspect included in the existing aspect model.

19. The method of claim 14, the adding further comprising utilizing an ascertained mixing ratio and a determined relevancy score.

20. A system that effectuates aspect model construction and notification, comprising:
means for continuously applying a dynamically expandable clustering series to a stream of data that comprises extractable aspects until an ascertainable stop condition is satisfied and extracting an extractable aspect;
means for receiving one or more user preferences;
means for ascertaining a match between the extractable aspect and the one or more user preferences; and
means for notifying one or more users of the match.
